(19) United States
(12) Patent Application Publication
(10) Pub. No.: US 2006/0255732 A1
(43) Pub. Date: Nov. 16, 2006

(54) Plasma display panel

(76) Inventors: Eui-Jeong Hwang, Suwon-si (KR); Min-Sun Yoo, Suwon-si (KR); Yon-Goo Park, Suwon-si (KR); Tae-Ho Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/400,245

(22) Filed: Apr. 10, 2006

(30) Foreign Application Priority Data
May 10, 2005 (KR) 10-2005-0038800

(51) Int. Cl. H01J 17/02

(52) U.S. Cl. 313/609

(57) ABSTRACT

A plasma display panel includes first and second substrates spaced apart from each other, barrier ribs partitioning the space between the first and second substrates into a plurality of discharge cells, at least one first electrode extending in a first direction, and at least one second electrode extending in a second direction crossing the first direction, wherein the second electrode includes a principal electrode and an auxiliary electrode intersecting the principal electrode.

### BACKGROUND OF THE INVENTION

1. Field of the Invention

The present invention relates to a plasma display panel. More particularly, the present invention relates to a plasma display panel having a structure for generating stable plasma discharge.

2. Description of the Related Art

In general, a plasma display panel (PDP) is a display device for displaying an image using visible light. In detail, the visible light is generated when a phosphor is excited by vacuum ultraviolet (VUV) light, which is generated by a plasma formed by an electrical discharge in a gas. PDPs can be used to form displays having large, high resolution screens and, thus, are particularly attractive as next-generation flat-panel display devices.

A PDP that implements a three-electrode surface-discharge scheme is one example of a PDP. In the three-electrode surface-discharge scheme, pairs of display electrodes may be formed on a front substrate, and address electrodes may be formed on a rear substrate that is spaced apart from the front substrate by a predetermined distance. The space between the front substrate and the rear substrate may be partitioned into a plurality of discharge cells by barrier ribs. Phosphor layers are typically formed in the discharge cells, e.g., on the rear substrate and/or the barrier ribs, and each discharge cell is filled with a discharge gas.

A discharge cell may be discharged by an address discharge occurring between the address electrode and one of the display electrodes.

A sustain discharge, with which the image is actually displayed, may occur between adjacent display electrodes.

In the conventional PDP, the display electrodes typically have a stripe shape. That is, the display electrodes may be disposed in parallel rows of linear elements. However, the stripe shape is not ideal when one considers the path of electrical discharge and distribution of charged particles generated thereby. For example, the discharge may be concentrated in a certain region of the discharge cell, while a lesser amount of discharge occurs in another region of the discharge cell. Accordingly, in the conventional PDP, many charged particles may accumulate in some regions without contributing significantly to discharge, and thus discharge efficiency may deteriorate, undesired discharges may occur, etc.

The description of the related art provided above is not prior art, but is merely a general overview that is provided to enhance an understanding of the art, and does not necessarily correspond to a particular structure or device.

### SUMMARY OF THE INVENTION

The present invention is therefore directed to a PDP, which substantially overcomes one or more of the problems due to the limitations and disadvantages of the related art.

It is therefore a feature of an embodiment of the present invention to provide a PDP having a structure that generates a stable plasma discharge.

It is therefore another feature of an embodiment of the present invention to provide a PDP having an electrode structure that includes principal and auxiliary electrodes that work together to generate a stable plasma discharge.

It is therefore a further feature of an embodiment of the present invention to provide a PDP that does not require transparent electrodes.

At least one of the above and other features and advantages of the present invention may be realized by providing a plasma display panel including first and second substrates spaced apart from each other, barrier ribs partitioning the space between the first and second substrates into a plurality of discharge cells, at least one first electrode extending in a first direction, and at least one second electrode extending in a second direction crossing the first direction, wherein the second electrode includes a principal electrode and an auxiliary electrode intersecting the principal electrode.

The auxiliary electrode may include a plurality of first members corresponding to central portions of the discharge cells, and a plurality of second members connecting the first members to the principal electrode.

The second members may intersect the principal electrode and connect two first members, the two first members corresponding to two adjacent discharge cells, respectively. The adjacent discharge cells may be in adjacent rows of discharge cells, the rows extending in the second direction. Each discharge cell may include two first members disposed to oppose each other. One of the two first members may be connected to a first principal electrode, and the other of the two first members may be connected to a second principal electrode, and a minimum distance between the two first members may be less than or equal to a minimum distance between the first and second principal electrodes, as determined from a center line of the discharge cell, the center line extending in the second direction.

The first members may extend in the second direction. The first members may be substantially linear. Lengths A and B may satisfy the following condition: 1/10≦B/A≦⅔, where A indicates a length of a discharge cell in the second direction and B indicates a length of a first member in the second direction. The lengths A and B may satisfy the following condition: 1/10≦B/A≦½.

Each discharge cell may include an auxiliary electrode that intersects a principal electrode at least two times. The principal electrode may be common to adjacent discharge cells. The adjacent discharge cells may be disposed in adjacent rows extending in the second direction, the adjacent discharge cells in adjacent rows may be defined in part by barrier ribs common thereto, and the principal electrode may extend along the common barrier ribs. Centers of three adjacent discharge cells constituting one pixel may be disposed to form a triangle, one of the three adjacent discharge cells may correspond to a first row of discharge cells, the other two of the three adjacent discharge cells may correspond to a second row of discharge cells, and the principal electrode may be common to the first and second rows. The three adjacent discharge cells may be hexagonal. The principal electrode may have a zigzag shape.

A width of the auxiliary electrode may be thinner than a width of the principal electrode. The principal electrode may include a metallic member. The auxiliary electrode may include a metallic member. The first electrode may be an address electrode and the second electrode may be a display electrode.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partial exploded perspective view of a PDP according to an embodiment of the present invention; and

FIG. 2 illustrates a partial plan view of the PDP of FIG. 1.

### DETAILED DESCRIPTION OF THE INVENTION

Korean Patent Application No. 10-2005-0038800, filed on May 10, 2005, in the Korean Intellectual Property Office, and entitled: “Plasma Display Panel” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A PDP according to the present invention may have a structure that includes principal and auxiliary electrodes that work together to generate a stable plasma discharge. The auxiliary electrodes may extend over discharge cells and may cross, and be connected to, the principal electrodes, which may enable the reduction or elimination of brightness differences. In addition, the nature of the plasma discharge may be enhanced by the electrode structure according to the present invention, and transparent electrodes may not be required. For example, the discharge firing voltage may be lowered because the discharge may be fired across a short gap, while discharge may be maintained across a longer gap to enhance the efficiency of the discharge.

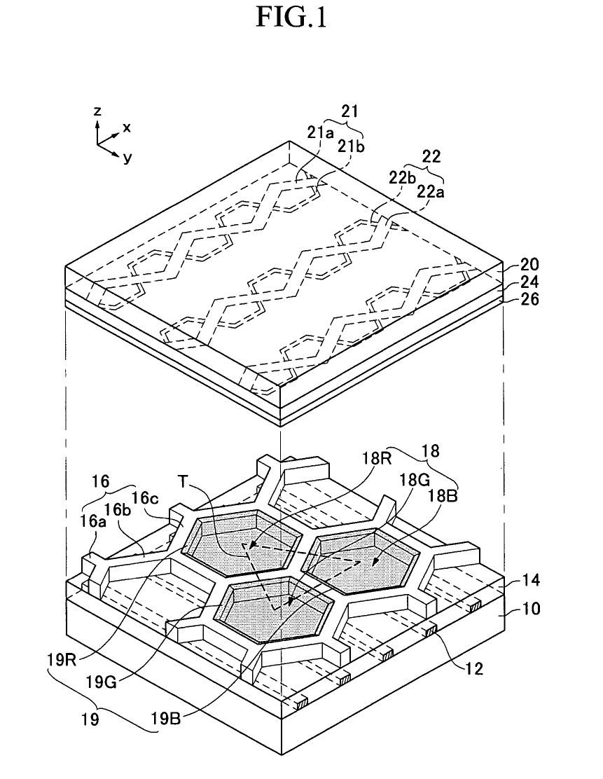

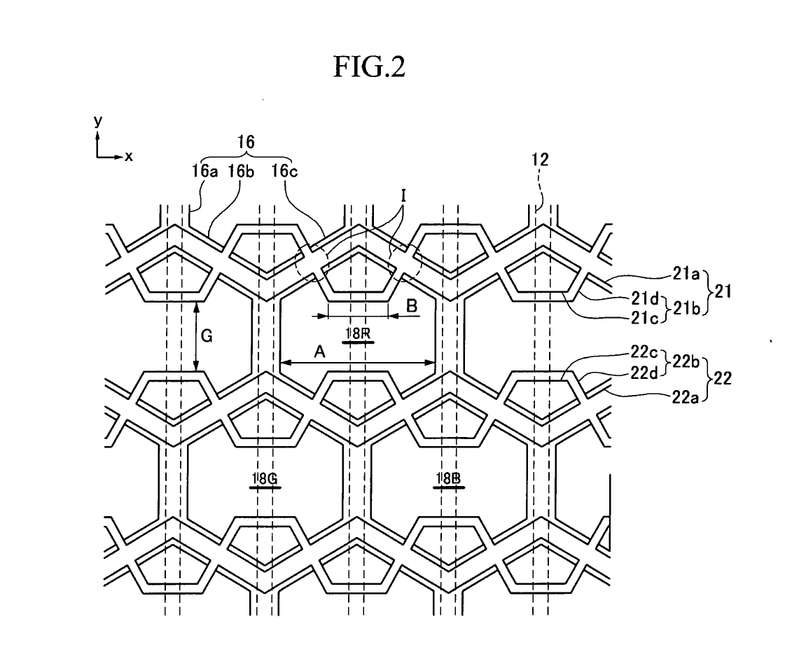

FIG. 1 illustrates a partial exploded perspective view of a PDP according to an embodiment of the present invention, and FIG. 2 is a partial plan view illustrating the PDP of FIG. 1. Referring to the FIG. 1, a PDP according to the present embodiment may include a first substrate 10 and a second substrate 20. For convenience and clarity of explanation, the first substrate 10 will be referred to as the rear substrate and the second substrate 20 will be referred to as the front substrate, although the present invention is not limited to this configuration.

The front substrate 20 may face, and be spaced apart from, the rear substrate 10, and barrier ribs 16 may partition the space therebetween into a plurality of discharge cells 18. A phosphor layer 19 may be formed in each discharge cell 18. The phosphor layer 19 may be on the rear substrate 10 and/or on the barrier ribs 16. Electrodes 12, 21 and 22 for generating plasma discharge and VUV light to excite the phosphor layer 18 may be disposed to correspond to each discharge cell 18.

In detail, the barrier ribs 16 may include barrier rib members 16a, 16b and 16c that partition the plurality of discharge cells 18. The barrier ribs 16 may be formed on a dielectric layer 14. A discharge gas, e.g., a mixture of xenon (Xe) and neon (Ne), may be filled into the discharge cells 18 to generate the VUV light using plasma discharge. The phosphor layers may include, e.g., a red phosphor layer 19R, a green phosphor layer 19G and a blue phosphor layer 19B, which may be separately formed in neighboring discharge cells 18R, 18G and 18B, respectively, to absorb the VUV light generated by the plasma discharge, and, in turn, thereby emit visible light.

The first through third barrier rib members 16a, 16b and 16c may form a plurality of discharge cells 18 that share common barrier rib members 16a, 16b and 16c. The discharge cells 18 may have, e.g., a regular hexagonal shape. As illustrated, first barrier rib members 16a may be formed to extend along a first direction, i.e., the y-axis in FIG. 1. The second and third barrier rib members 16b and 16c may be inclined relative to the first barrier rib members 16a, such that they extend along the rear substrate 10 in opposing directions that intersect the first direction. A plurality of second and third barrier rib members 16b and 16c may form a zigzag pattern that is centered along a second direction, i.e., the x-axis illustrated in FIG. 1. The second direction may be substantially orthogonal to the first direction.

Where the discharge cell 18 has a hexagonal shape, the length of the discharge cell 18 in the second direction becomes less moving away from the centerline of the discharge cell 18. That is, where a pair of first barrier rib members 16a are oriented along the first direction and form opposing, parallel sides of the hexagonal discharge cell 18, two pairs of second and third barrier rib members 16b, 16c may be inclined such that they intersect to form opposing angles of the hexagonal discharge cell 18.

Three adjacent discharge cells 18R, 18G and 18B having the red phosphor layer 19R, the green phosphor layer 19G and the blue phosphor layer 19B, respectively, may form one pixel. The centers of the three adjacent discharge cells 18R, 18G and 18B may be disposed at three corners of a triangle T, as illustrated in FIG. 1. Of course, the triangle T is merely a hypothetical triangle that describes the spatial relationship between the three adjacent discharge cells 18R, 18G and 18B.

While the barrier ribs 16 define hexagonal discharge cells 18 in FIG. 1, it will be appreciated that variously-shaped discharge cells 18 may be formed by using variously shaped barrier ribs 16, and the present invention is not limited to the configuration described above.

The first electrodes 12 may extend in the first direction. In the illustrated embodiment, the first electrodes 12 may be address electrodes formed along the first direction. These address electrodes 12 may be formed on a surface of the rear substrate 10 that faces the front substrate 20 and may underlie the barrier ribs 16. Multiple address electrodes 12 may be disposed adjacent to each other and may be spaced apart by a predetermined distance. A dielectric layer 14 may be formed over the entire surface of the rear substrate 10 to cover the address electrodes 12.

The second electrodes 21 and 22 may be formed on a surface of the front substrate 20 that faces the rear substrate 10. The second electrodes 21, 22 may serve as display electrodes. The display electrodes 21 and 22 may generally extend in the second direction so as to cross the address electrodes 12.

A dielectric layer 24 and a protective film 26, e.g., a MgO film, may be sequentially formed over the entire surface of the front substrate 20 to cover the display electrodes 21 and 22. The protective film 26 may protect the dielectric layer 24 from damage resulting from the impact of ions generated by the plasma discharge. The protective film 26 may exhibit a high secondary electron emission coefficient. Accordingly, it may emit secondary electrons to improve the efficiency of discharge.

The display electrodes 21 and 22 may include sustain electrodes 21 and scan electrodes 22. The scan electrodes 22 may be used, along with the address electrodes 12, for an address discharge during an address period to select a discharge cell 18 to be turned on. The sustain electrodes 21 may be used, along with the scan electrodes 22, for a sustain discharge during a sustain period to display a pixel or R, G or B sub-pixel at a predetermined luminance. However, different signals and voltages may be applied to each of the electrodes, such that each electrode may perform a different function. Accordingly, it will be appreciated that the present invention is not limited to the example just described.

The scan electrodes 21 and 22 may each include a principal electrode 21a and 22a, respectively. The scan electrodes 21 and 22 may also each include an auxiliary electrode 21b and 22b, respectively. The principal electrodes 21a and 22a may correspond to the portion of the barrier ribs 16 defined by the second and third barrier rib members 16b and 16c. That is, the principal electrodes 21a and 22a may overlie and extend along the portions of the barrier ribs 16 defined by the second and third barrier rib members 16b and 16c. Thus, if the discharge cells 18 are hexagonal, the principal electrodes 21a and 22a may have a zigzag shape, i.e., extend in the second direction in a zigzag pattern.

The principal electrodes 21a and 22a may provide a display signal to adjacent discharge cells 18, where the discharge cells are adjacent to each other in the first direction. In detail, the PDP may have rows of discharge cells 18 extending in the second direction. Neighboring discharge cells 18 may share common barrier rib members 16a, 16b and 16c. In particular, neighboring discharge cells 18 in adjacent rows may share common barrier rib members 16b and 16c, but not barrier rib members 16a. As the principal electrodes 21a and 22a may extend along the common barrier rib members 16b and 16c, they may each be suitably disposed to serve neighboring discharge cells 18 in adjacent rows.

The auxiliary electrodes 21b and 22b may be disposed to extend in the second direction so as to generally follow the principal electrodes 21a and 22a, respectively. However, the auxiliary electrodes 21b and 22b may have a shape that does not extend along the barrier rib members 16b and 16c, so that the auxiliary electrodes 21b and 22b may be disposed over the open region of the discharge cells 18, rather than along the barrier ribs 16b and 16c defining the common edges thereof.

In particular, referring to FIG. 2, the auxiliary electrodes 21b and 22b may include, respectively, first members 21c and 22c and second members 21d and 22d. The first members 21c and 22c may correspond to a central portion of the discharge cell 18, i.e., they may be disposed over the discharge cell 18 towards the center thereof. The first member 21c of the sustain electrode 21 and the first member 22c of the scan electrode 22 may oppose each other in respective discharge cells 18. That is, as illustrated in FIG. 2, a given discharge cell 18 may have one first member 21c of the sustain electrode 21 and one first member 22c of the scan electrode 22 overlying the discharge cell 18. The first members 21c and 22c may be straight and disposed parallel to each other extending in the second direction. The first members 21c and 22c may be separated by a gap G.

The second members 21d and 22d may intersect the first members 21c and 22c and connect them to the principal electrodes 21a and 22a, respectively, as indicated by intersections I illustrated in FIG. 2. In detail, the second member 21d of the sustain electrode 21 may connect a pair of the first members 21c by intersecting the principal electrode 21a. Similarly, the second member 22d of the scan electrode may connect a pair of the first members 22c by intersecting the principal electrode 22a. Thus, the pair of the first members 21c, which correspond to two neighboring discharge cells 18 in adjacent rows, are connected to the same principle electrode 21a by the second members 21d. The pair of first members 22c may be similarly connected. Accordingly, as illustrated in FIG. 2, one discharge cell 18 may be served by two first members (21c and 22c), which are connected to the two principle electrodes (21a and 22a) by four second members (two of 21d and two of 22d). Further, the same four second members may extend across into discharge cells 18 in adjacent rows, where additional sets of first members are disposed. Thus, the auxiliary electrodes 21b and 22b extend to intersect the principal electrodes 21a and 22a at least two times at the respective discharge cells 18, as indicated by the intersections I.

The principal electrodes 21a and 22a may be formed of a metal and may thus have excellent electrical conductivity. In particular, because the principal electrodes 21a and 22a are formed to correspond to the second and third barrier rib members 16b and 16c, they need not be transparent. Also, the auxiliary electrodes 21b and 22b may be formed of a metal and need not be transparent. In particular, the width of the auxiliary electrodes 21b and 22b may be thin (i.e., thin in width as defined along the plane of the substrate), so as to maximize the amount of visible light, generated via discharge and phosphor excitement, that exits the discharge cells 18. In addition, these electrodes 21b and 22b may be thinner than the principal electrodes 21a and 22a to reduce current consumption.

The sustain discharge generated between the sustain electrode 21 and scan electrode 22 may be fired across the relatively short gap G that exits between the first portions 21c and 22c that are opposite each other in a given discharge cell 18. Further, as the discharge is diffused along the second portions 21d and 22d, it spans a longer gap between the primary electrodes 21a and 22a, thereby increasing the area of the discharge cell 18 that is involved in plasma discharge and visible light emission. Thus, according to the present invention, the discharge firing voltage may be lowered because the discharge is fired at a short gap G, while the discharge efficiency may be enhanced because the main discharge is maintained at a long gap, greater than the gap G. Also, discharge diffusion into the long gap is facilitated since the second members 21d and 22d of auxiliary electrodes 21b and 22b connect the first members 21c and 22c and the primary electrode 21a and 22a, and the plasma discharge may diffuse along those connections.

According to the present invention, the flow of electricity for discharge is facilitated in the entire panel because the auxiliary electrodes 21b and 22b may extend and intersect the principal electrodes 21a and 22a at least two times at the respective discharge cells 18. Accordingly, this arrangement may reduce or prevent brightness differences between discharge cells 18. Otherwise, brightness differences may be generated when the flow of electricity for discharge is insufficient, and some portions of discharge cells 18 are relatively bright while other portions of discharge cells 18 are relatively dark.

In an embodiment of the present invention, the lengths of the first members 21c and 22c may be determined with respect to the size of the discharge cells 18. In particular, the length A of a discharge cell 18, as measured in the second direction (x-axis direction in FIGS. 1 and 2), and the length B of first members 21c, 22c, also measured in the second direction, may each be established to satisfy the following Formula 1:
1/10≦B/A≦⅔ (1).

When the value of B/A is less than 1/10, the sustain discharge may be unsatisfactorily fired because the first members 21c and 22c, which are opposite to each other in the discharge cell 18 and serve to fire the discharge, may be too short.

Furthermore, it is desirable that charged particles diffuse in a vertical direction (y-axis direction in the drawings) of the discharge cell 18 to promote effective long gap discharge. However, when the value of B/A exceeds ⅔, charged particles may diffuse in a horizontal direction (x-axis direction in the drawings) of the discharge cells 18, and thus the discharge may be prevented from diffusing into the long gap between the primary electrodes 21a and 22a. In addition, charged particles that substantially relate to discharge may be lost and erroneous discharge may be generated by charged particles that are accumulated at the horizontal edge of the discharge cell 18.

In summary, the value of B/A may be optimized in consideration of the plasma discharge path and distribution of charged particles in the plasma discharge which may not be significantly contributing to the plasma discharge. Moreover, the value of B/A may be optimized in consideration of the discharge firing voltage required to initiate and/or maintain the plasma discharge. Thus, according to the present invention, plasma discharge may be stably generated while the efficiency of discharge is enhanced.

To further improve the above effect, the lengths A and B may satisfy the following Formula 2:
1/10≦B/A≦½ (2).

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
first and second substrates spaced apart from each other;
barrier ribs partitioning the space between the first and second substrates into a plurality of discharge cells;
at least one first electrode extending in a first direction; and
at least one second electrode extending in a second direction crossing the first direction, wherein the second electrode includes:
a principal electrode, and
an auxiliary electrode intersecting the principal electrode.

2. The plasma display panel as claimed in claim 1, wherein the auxiliary electrode includes a plurality of first members corresponding to central portions of the discharge cells, and a plurality of second members connecting the first members to the principal electrode.

3. The plasma display panel as claimed in claim 2, wherein the second members intersect the principal electrode and connect two first members, the two first members corresponding to two adjacent discharge cells.

4. The plasma display panel as claimed in claim 3, wherein the adjacent discharge cells are in adjacent rows of discharge cells, the rows extending in the second direction.

5. The plasma display panel as claimed in claim 2, wherein each discharge cell includes two first members disposed to oppose each other.

6. The plasma display panel as claimed in claim 5, wherein one of the two first members is connected to a first principal electrode, and the other of the two first members is connected to a second principal electrode, and
a minimum distance between the two first members is less than or equal to a minimum distance between the first and second principal electrodes, as determined from a center line of the discharge cell, the center line extending in the second direction.

7. The plasma display panel as claimed in claim 2, wherein the first members extend in the second direction.

8. The plasma display panel as claimed in claim 7, wherein the first members are substantially linear.

9. The plasma display panel as claimed in claim 7, wherein lengths A and B satisfy the following condition:
1/10≦B/A≦⅔,
where A indicates a length of a discharge cell in the second direction and B indicates a length of a first member in the second direction.

10. The plasma display panel as claimed in claim 9, wherein the lengths A and B satisfy the following condition:
1/10≦B/A≦½.

11. The plasma display panel as claimed in claim 1, wherein each discharge cell includes an auxiliary electrode that intersects a principal electrode at least two times.

12. The plasma display panel as claimed in claim 1, wherein the principal electrode is common to adjacent discharge cells.

13. The plasma display panel as claimed in claim 12, wherein the adjacent discharge cells are disposed in adjacent rows extending in the second direction,
the adjacent discharge cells in adjacent rows are defined in part by barrier ribs common thereto, and
the principal electrode extends along the common barrier ribs.

14. The plasma display panel as claimed in claim 12, wherein centers of three adjacent discharge cells constituting one pixel are disposed to form a triangle,
one of the three adjacent discharge cells corresponds to a first row of discharge cells,
the other two of the three adjacent discharge cells correspond to a second row of discharge cells, and
the principal electrode is common to the first and second rows.

15. The plasma display panel as claimed in claim 14, wherein the three adjacent discharge cells are hexagonal.

16. The plasma display panel as claimed in claim 12, wherein the principal electrode has a zigzag shape.

17. The plasma display panel as claimed in claim 1, wherein a width of the auxiliary electrode is thinner than a width of the principal electrode.

18. The plasma display panel as claimed in claim 1, wherein the principal electrode comprises a metallic member.

19. The plasma display panel as claimed in claim 1, wherein the auxiliary electrode comprises a metallic member.

20. The plasma display panel as claimed in claim 1, wherein the first electrode is an address electrode and the second electrode is a display electrode.
